(19) United States
(12) Patent Application Publication
(10) Pub. No.: US 2025/0155616 A1
(43) Pub. Date: May 15, 2025

(54) MICROSPHERES COMPRISING ALUMINA AND ZIRCONIA SUITABLE FOR RETROREFLECTIVE ARTICLES

(71) Applicant: 3M INNOVATIVE PROPERTIES COMPANY, St. Paul, MN (US)

(72) Inventors: Craig W. Lindsay, Arden Hills, MN (US); Anatoly Z. Rosenflanz, Maplewood, MN (US); Billy J. Frederick, JR., Woodbury, MN (US); Jacqueline C. Rolf, River Falls, WI (US); Joseph D. Engebretson, St. Croix Falls, WI (US); Luke E. Heinzen, Shoreview, MN (US)

(21) Appl. No.: 18/836,944

(22) PCT Filed: Feb. 28, 2023
(86) PCT No.: PCT/IB2023/051861

§ 371 Date: Aug. 8, 2024

Related U.S. Application Data
(60) Provisional application No. 63/318,059, filed on Mar. 9, 2022.

(51) Int. Cl. G02B 5/128; C03C 3/062; C03C 12/02; C04B 35/119; C04B 35/488; E01F 9/524

(52) U.S. Cl. CPC G02B 5/128; C03C 3/062; C03C 12/02; C04B 35/119; C04B 35/4885; C04B 2235/3418; C04B 2235/528; C04B 2235/77; C04B 2235/9646; C04B 2235/9661; E01F 9/524

(57) ABSTRACT

Microspheres and retroreflective articles are described. In one embodiment, the microspheres comprise at least 40 wt. % alumina, at least 35 wt. % zirconia, and silica. In another embodiment, the microspheres comprise at least 80, 85, or 90 wt. % of a combination of alumina, zirconia, and silica and the microspheres have a density of at least 3.

### SUMMARY

Presently described are microspheres and retroreflective articles. In one embodiment, retroreflective articles are described comprising microspheres disposed on a surface of the article. In some embodiments, the article is a pavement marking or pavement marking tape. In other embodiments, the retroreflective article is a retroreflective element comprising a core particle comprising the microspheres disposed on at least a portion of a surface of the core particle.

In one embodiment, the microspheres comprise at least 40 wt. % alumina, at least 35 wt. % zirconia, and silica.

In another embodiment, the microspheres comprise at least 80, 85, or 90 wt. % of a combination of alumina, zirconia, and silica and the microspheres have a density of at least 3.4.

### BRIEF DESCRIPTION OF THE DRAWINGS

FIG. 1 is a cross-sectional view of an illustrative retroreflective element;

FIG. 2 is a perspective view of an illustrative pavement marking;

FIG. 3 is a cross-sectional view of an illustrative pavement marking tape.

### DETAILED DESCRIPTION

The microspheres generally comprise zirconia (i.e. ZrO₂), aluminum oxide (i.e. Al₂O₃), and silica (i.e. SiO₂). This base composition will be referred to herein as “ZAS”. Beads that include the ZAS base composition will be referred to as “ZAS beads” or “ZAS microspheres.” The terms “beads” and “microspheres” are used interchangeably and refer to particles that are substantially spherical.

The term “solid” refers to beads that are not hollow, i.e., free of substantial cavities or voids. For use as lens elements, the beads are preferably spherical and preferably solid (i.e. non-porous). Solid beads are typically more durable than hollow beads. Solid beads can also focus light more effectively than hollow beads, leading to higher retroreflectivity. The microspheres described herein are preferably transparent.

The term “transparent” means that the beads when viewed under an optical microscope (e.g., at 100×) have the property of transmitting rays of visible light so that bodies beneath the beads, such as bodies of the same nature as the beads, can be clearly seen through the beads when both are immersed in oil of approximately the same refractive index as the beads. Although the oil should have an index of refraction approximating that of the beads, it should not be so close that the beads seem to disappear (as they would in the case of a perfect index match). The outline, periphery, or edges of bodies beneath the beads are clearly discernible.

The transparent beads described herein typically have an index of refraction of at least 1.72. In some embodiments, the transparent beads have a refractive index of at least 1.72, 1.73, 1.74, 1.75, 1.76, 1.77, 1.78, 1.79, 1.80, 1.81, 1.82, 1.83, 1.84 or 1.85. In some embodiments, the refractive index of the transparent beads is no greater than 1.92, 1.91, 1.90, 1.89, 1.88, 1.87, 1.86, 1.85, 1,84, or 1.83. In some embodiments, the refractive index of the transparent beads is no greater than 1.82, 1.81, 1.80, 1.79, 1.78, 1.76, or 1.75.

The described microspheres are particularly useful as lens elements in retroreflective articles. Articles of the invention share the common feature of comprising the ZAS beads described disposed on a surface of the article. Thus, at least a portion of the ZAS beads and/or reflective elements are exposed on the viewing surface of the article (e.g. pavement marking). The microspheres and/or reflective elements are preferably embedded in a binder or core particle at a depth ranging from about 30% to about 60% of their diameters.

The pavement markings described herein comprise a binder. The binder affixes the microspheres or the elements comprising microspheres to a pavement surface. Pavement surfaces are typically substantially solid and include a major portion of inorganic materials. Typically pavement surfaces include asphalt, concrete, and the like. The binder typically comprises a paint, a thermoplastic material, thermoset material, or other curable material. Common binder materials include polyacrylates, methacrylates, polyolefins, polyurethanes, polyepoxide resins, phenolic resins, and polyesters. For reflective pavement marking paints the binder may comprise reflective pigment.

For reflective sheeting that is suitable for reflective signage, apparel, or other uses, the binder that affixes the beads is typically transparent. Transparent binders are applied to a reflective base or may be applied to a release-coated support, from which after solidification of the binder, the beaded film is stripped and may subsequently be applied to a reflective base or be given a reflective coating or plating. The reflective elements comprising microspheres and/or the microspheres are typically coated with one or more surface treatments that alter the pavement marking binder wetting properties and/or improve the adhesion of the reflective elements comprising microspheres or the microspheres in the binder. The reflective elements are preferably embedded in the pavement marking binder to about 20-40%, and more preferably to about 30% of their diameters such that the reflective elements are adequately exposed. Surface treatments that control wetting include various fluorochemical derivatives such as commercially available from Du Pont, Wilmington, DE under the trade designation “Krytox 157 FS”. Various silanes such as commercially available from OSI Specialties, Danbury, CT under the trade designation “Silquest A-1100” are suitable as adhesion promoters.

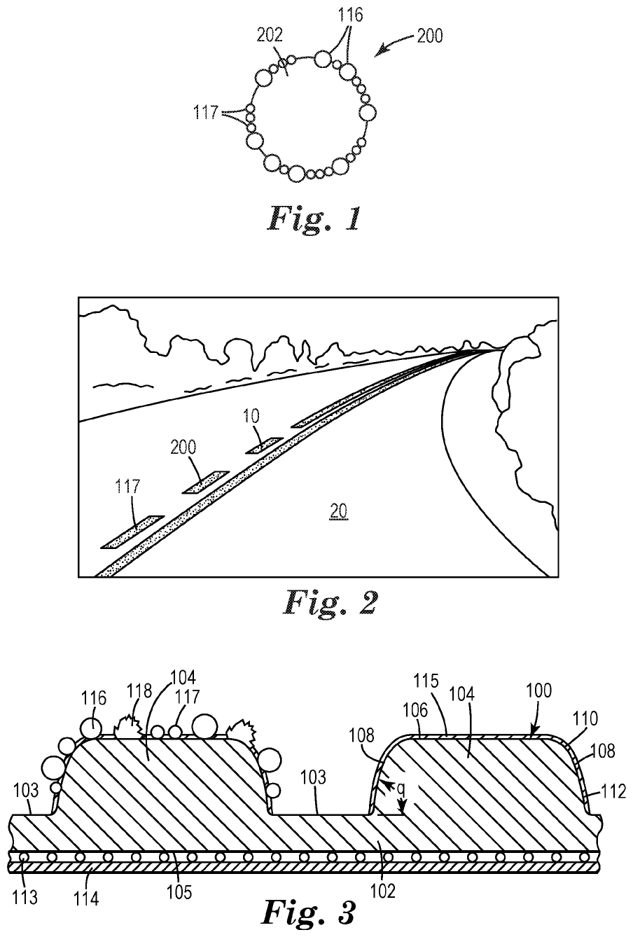

In some embodiments, the retroreflective article is a retroreflective element comprising a core particle comprising the microspheres at least partially embedded in a core. With reference to FIG. 1, retroreflective element 200 comprises ZAS microspheres 117 alone or in combination with higher index beads (e.g. having a refractive index of at least 2.20 or greater) 116 partially embedded in the surface of a core 202. The core is typically substantially larger than the beads. For example the average core diameter may range from about 0.2 to about 10 millimeters. The core may comprise an inorganic material. Glass-ceramics are also useful as a core material. The crystalline phase acts to scatter light resulting in a semi-transparent or opaque appearance. Alternatively, the core may comprise an organic material such as a thermoplastic or bonded resin core, i.e. a crosslinked cured resin such as an epoxy, polyurethanes, alkyds, acrylics, polyesters, phenolics and the like. Various epoxies, polyurethane, and polyesters are generally described in U.S. Pat. Nos. 3,254,563; 3,418,896 and 3,272,827. The core may be a composite comprising an inorganic particle that is coated with an organic material. In the latter case, the organic material serves as a binder to affix the beads to the outside surface of the core.

Although the retroreflective elements may be prepared from a non-diffusely reflecting bonded resin core in combination with specularly reflecting microspheres (e.g. vapor coating the microspheres with aluminum), this approach results in less durable retroreflective elements due to the use of metal which may be susceptible to chemical degradation. Less durable retroreflective elements would also result by incorporating metals (e.g. aluminum) into the core. In some embodiments, the retroreflective elements comprise at least one non-metallic light scattering material dispersed within core. Reflective elements may be made by known processes, such as described in U.S. Pat. Nos. 5,917,652; 5,774,265; and 2005/0158461.

The retroreflectance of the microspheres and/or retroreflective elements for an entrance angle of −4° and a 0.2° observation angle (as determined according to the test method of the examples) is at least 8, 9, 10, 11, 12, 13, 14 or 15 (Cd/m²)/lux. In some embodiments, the retroreflectance of the microspheres and/or retroreflective elements is no greater than 15, 14, 13, 12, 11, 10, 9, or 8 (Cd/m²)/lux. Microspheres of lower refractive index and brightness (in air) can be used with higher refractive index beads.

In some aspects, the beads and/or retroreflective elements are employed in liquid-applied marking (e.g. pavement) applications. With reference to FIG. 2, the beads 117 and/or reflective elements 200 are sequentially or concurrently dropped onto a liquified binder 10 or compounded within a liquified binder that is provided on pavement surface 20. In other aspects, beads and/or reflective elements are employed in retroreflective sheeting including exposed lens, encapsulated lens, embedded lens, or enclosed lens sheeting. Representative pavement-marking sheet material (tapes) are described in U.S. Pat. No. 4,248,932 (Tung et al.), U.S. Pat. No. 4,988,555 (Hedblom); U.S. Pat. No. 5,227,221 (Hedblom); U.S. Pat. No. 5,777,791 (Hedblom); and U.S. Pat. No. 6,365,262 (Hedblom).

Pavement marking tape and sheet material generally includes a backing, a layer of binder material, and a layer of beads partially embedded in the layer of binder material. The backing, which is typically of a thickness of less than about 3 millimeters, can be made from various materials, e.g., polymeric films, metal foils, and fiber-based sheets. Suitable polymeric materials include acrylonitrile-butadiene polymers, millable polyurethanes, and neoprene rubber. The backing can also include particulate fillers or skid resistant particles. The binder material can include various materials, e.g., vinyl polymers, polyurethanes, epoxides, and polyesters, optionally with colorants such as inorganic pigments, including specular pigments. The pavement marking sheeting can also include an adhesive, e.g., a pressure sensitive adhesive, a contact adhesive, or a hot melt adhesive, on the bottom of the backing sheet.

Patterned retroreflective (e.g. pavement) markings advantageously provide vertical surfaces, e.g., defined by protrusions, in which the microspheres are partially embedded. Because the light source usually strikes a pavement marker at high entrance angles, the vertical surfaces, containing embedded microspheres, provide for more effective retroreflection. Vertical surfaces also tend to keep the microspheres out of the water during rainy periods thereby improving retroreflective performance.

For example, FIG. 3 shows patterned pavement marker 100 containing a (e.g. resilient) polymeric base sheet 102 and a plurality of protrusions 104. For illustrative purposes, only one protrusion 104 has been covered with microspheres and antiskid particles. Base sheet 102 has front surface 103 from which the protrusions extend, and back surface 105. Base sheet 102 is typically about 1 millimeter (0.04 inch) thick, but may be of other dimensions if desired. Optionally, maker 100 may further comprise scrim 113 and/or adhesive layer 114 on back surface 105. Protrusion 104 has top surface 106, side surfaces 108, and in an illustrative embodiment is about 2 millimeters (0.08 inch) high. Protrusions with other dimensions may be used if desired. As shown, side surfaces 108 meet top surface 106 at a rounded top portions 110. Side surfaces 108 preferably form an angle 0 of about 700 at the intersection of front surface 103 with lower portion 112 of side surfaces 108. Protrusion 104 is coated with pigment-containing binder layer 115. Embedded in binder layer 115 are a plurality of ZAS microspheres 117 and a plurality of a second microspheres 116 (e.g. having a higher refractive index than the ZASmicrospheres). Optionally, antiskid particles 118 may be embedded on binder layer 115.

Pavement marking sheeting can be made by a variety of known processes. A representative example of such a process includes coating onto a backing sheet a mixture of resin, pigment, and solvent, dropping beads as described herein onto the wet surface of the backing, and curing the construction. A layer of adhesive can then be coated onto the bottom of the backing sheet. U.S. Pat. No. 4,988,541 (Hedblom) discloses a preferred method of making patterned pavement markings and is. Optionally, a scrim (e.g., woven or nonwoven) and/or an adhesive layer can be attached to the back side of the polymeric base sheet, if desired.

In some embodied retroreflective articles, two types of microspheres are employed wherein one type are the ZAS beads described herein and the second type are “higher index microspheres,” having for example a refractive index of at least 2.1, 2.2, or 2.3 and typically no greater than 2.45. In some aspects, one of the two types of microspheres will be larger. For instance, the ZAS microspheres, ranging in size from 50 to 150 micrometers in diameter may be disposed in combination with larger or smaller beads.

The ZAS microspheres alone or in combination with optional non-ZAS beads are typically present in an amount of at least 15, 20, 25, 30 or 35 weight percent of the total amount of microspheres of the reflective article. In some embodiments, the ZAS microspheres alone or in combination with optional non-ZAS beads are present in an amount no greater than 85, 80, or 75 weight percent of the total amount of microspheres.

The microspheres are preferably placed selectively on the side and top surfaces of the protrusions while leaving the valleys between protrusions substantially clear so as to minimize the amount of microspheres, thereby minimizing the manufacturing cost. The microspheres may be placed on any of the side surfaces as well as the top surface of the protrusions to achieve efficient retroreflection.

The binder layer of FIGS. 2 and 3 as well as the core of the retroreflective element depicted in FIG. 1 comprise a light transmissive material so that light entering the retroreflective article is not absorbed but is instead retroreflected by way of scattering or reflection off of pigment particles in the light-transmissive material. Vinyls, acrylics, epoxies, and urethanes are examples of suitable mediums. Urethanes, such as are disclosed in U.S. Pat. No. 4,988,555 (Hedblom) are preferred binder mediums at least for pavement markings. The binder layer typically covers selected portions of the protrusions so that the base sheet remains substantially free of the binder. For ease of coating, the medium will preferably be a liquid with a viscosity of less than 10,000 centipoise at coating temperatures.

The binder layer of FIGS. 2 and 3 as well as the core of FIG. 1 typically comprise at least one pigment such as a diffusely reflecting or specularly reflecting pigment.

Specular pigment particles are generally thin and plate-like and are part of the binder layer, the organic core (a core comprising essentially only an organic binder material) of an element, or an organic binder coating on an inorganic particle that together make up a composite core of an element. Light striking the pigment particles is reflected at an angle equal but opposite to the angle at which it was incident. Suitable examples of specular pigments include pearlescent pigments, mica, and nacreous pigments. Typically, the amount of specular pigment present in the binder layer is at least 15 percent by weight ranging up to 40 or 50 percent by weight. Pearlescent pigment particle are often preferred because of the trueness in color.

In lieu of or in addition to combining transparent beads with a reflective (e.g. pigment containing) binder and/or element core, the beads may comprise a reflective (e.g. metallic) coating. Typically, the metallic coating is absent from the portion of the outside surface of the bead that is oriented to receive the light that is to be retroreflected, and present on the portion of the outside surface of the bead that is oriented opposite to the direction from which light that is to be retroreflected is incident. For example, in FIG. 1, a metallic coating may be placed at the interface between bead 117 and core 202. In FIG. 3, a reflective layer may be placed at the interface between the bead 117 and the binder 115 such as shown in U.S. Pat. No. 6,365,262. Metallic coatings may be placed on beads by physical vapor deposition means, such as evaporation or sputtering. Full coverage metallic coatings that are placed on beads can be partially removed by chemical etching.

The components of the beads are described as oxides, i.e. the form in which the components exist in the completely processed glass and glass-ceramic beads as well as retroreflective articles, and the form that correctly accounts for the chemical elements and the proportions thereof in the beads. The starting materials used to make the beads may include some chemical compound other than an oxide, such as a dispersant that are volatilized during the melting and spheroidizing process.

The microspheres described herein typically comprise at least 40 wt. % alumina (Al₂O₃). In typical embodiments, the microspheres comprise no greater than 60, 59, 58, 57, 56, or 55 wt. % of alumina. In some embodiments, the microspheres comprise at least at least 41, 42, 43, 44, 45, 46, 47, 48, 49, 50, 51, 52, 53, 54, 55, 56, 57, 58, 59, or 60 wt. % alumina. Microspheres comprising at least 40, 41, 42, 43, 44 or 45 wt. % alumina have good crush resistance. In other embodiments, the microspheres comprise no greater than 54, 53, 52, 51, 50, 49, 48, 47, 46, or 45 wt. % alumina.

The microspheres described herein typically comprise at least at least 30, 31, 32, 33, 34, or 35 wt. % zirconia (ZrO₂). In typical embodiments, the microspheres comprise no greater than 55, 54, 53, 52, 51 or 50 wt. % of zirconia. When the amount of zirconia is about 50 wt. %, the amount of alumina is typically greater than 30 wt. % and/or the amount of silica is less than 20 wt. %. In some embodiments, the microspheres comprise at least 36, 37, 38, 39, 40, 41, 42, 43, 44, 45, 46, 47, 48, 49, or 50 wt. % zirconia. Microspheres comprising at least 45, 46, 47, 48, 49 or 50 wt. % zirconia have good crush resistance. In other embodiments, the microspheres comprise no greater than 49, 48, 47, 46, 45, 44, 43, 42, 41, or 40 wt. % zirconia.

In some embodiments, the total amount of alumina and zirconia is at least 80, 85, 90 or 95 wt. % of the microspheres.

In some embodiment, the microspheres comprises about the same amount of alumina as zirconia. In other words, the weight ratio of alumina to zirconia is about 1:1. For example, the microspheres may comprise about 40 wt. % alumina and about 40 wt. % zirconia. As yet another example, the microspheres may comprise about 45 wt. % alumina and about 45 wt. % zirconia.

In other embodiments, the microspheres comprise more alumina than zirconia. For example, the microspheres may comprise about 55 wt. % alumina and about 35 wt. % zirconia. In this embodiment, the weight ratio of alumina to zirconia is at least 1.1:1, 1.2:1, 1.3:1, 1.4:1, 1.5:1, or 1.6:1.

In other embodiments, the microspheres comprise more zirconia than alumina. For example, the microspheres may comprise about 40 wt. % alumina and about 50 wt. % zirconia. In this embodiment, the weight ratio of zirconia to alumina can be at least 1.1:1, 1.2:1, 1.3:1, 1.4:1, 1.5:1, or 1.6:1.

The microspheres described herein typically comprise silica. In typical embodiments, the microspheres comprise at least 1, 2, 3, 4 or 5 wt. % silica. In some embodiments, the microspheres comprise no greater than 30, 29, 28, 27, 26, 25, 24, 23, 22, 21, or 20 wt. % silica. In some embodiments, the microspheres comprise at least 6, 7, 8, 9, or 10 wt. % silica. In some embodiments, the microspheres comprise at least 11, 12, 13, 14, or 15 wt. % silica. Microspheres comprising less than 15, 14, 13, 12, 11, or 10 wt. % silica exhibit good crush resistance. In some embodiments, the microspheres comprise at least 16, 17, 18, 19, or 20 wt. % silica. In some embodiments, the microspheres comprise no greater than 20, 19, 18, 17, 16, or 15 wt. % silica. In some embodiments, the microspheres comprise no greater than 14, 13, 12, 11, or 10 wt. % silica. In some embodiments, the microspheres comprise no greater than 9, 8, 7, 6, or 5 wt. % silica.

In some embodiments, the total amount of zirconia, alumina, and silica totals at least 85, 90, 95, or 100 wt. % of the microspheres. When the total amount of zirconia, alumina, and silica totals at least 85, 86, 87, 88, 89, or 90 wt. % of the microspheres, the microspheres exhibit good crush strength.

The microspheres described herein may comprise other metal oxides. The total amount of other metal oxides is no greater than 15 or 10 wt. % Such other metal oxides are selected as to not detract from the (e.g. brightness and/or durability) properties of the ZAS microspheres. Other metal oxides may be selected for addition with the purpose of lowering the melting point of the material, leading to easier processing. Suitable other metal oxides include for example LiO₂, Na₂O, K₂0, and alkaline earth oxides such as BaO, SrO, MgO, and CaO, AhO₃, ZnO, SiO₂, and B₂03. Other metal oxides may be selected for addition with the purpose of increasing the refractive index. Suitable other metal oxides include for example titania and rare earth oxides, such as lanthana.

In some embodiments, the microspheres comprise alkaline earth oxides, such as MgO and/or CaO. The amount of alkaline earth oxide(s) (e.g. MgO, CaO, or the sum thereof) is typically less than 10, 9, 8, 7, 6, or 5 wt. % of the microspheres. In some embodiments, the amount of alkaline earth oxide(s) is at least 1, 2, 3, 4, or 5 wt. % of the microspheres.

In some embodiments, the microspheres comprise titania. The amount of titania is typically less than 10, 9, 8, 7, 6, or 5 wt. % of the microspheres. In some embodiments, the amount of titania is at least 1, 2, 3, 4, or 5 wt. % of the microspheres.

In some embodiments, the microspheres comprise lanthana (La₂O₃). The amount of lanthana is typically less than 15, 14, 13, 12, 11 or 10 wt. % of the microspheres. In some embodiments, the amount of lanthana is at least 1, 2, 3, 4, or 5 wt. % of the microspheres. In some embodiments, the amount of lanthana is at least 6, 7, 8, 9, or 10 wt. % of the microspheres.

In some embodiments, the microspheres comprise a combination of titania and lanthana. In this embodiment, the amount of titania and lathana are within the amounts just described. Notably, sufficiently high brightness can be obtained in the absence of titania and lanthana.

In yet other embodiments, the microspheres comprise one or more (e.g. transition) metal oxides to impart color and/or fluorescence as known in the art. Such colorants include, for example, Fe₂O₃, CoO, Cr₂O₃, NiO, CuO, MnO₂, V₂Os and the like. Typically, the beads include no more than about 5% by weight (e.g. 1%, 2%, 3%, 4%) colorant, based on the total weight of the beads. Also, rare earth elements, such as praseodymium, neodymium, europium, erbium, thulium, ytterbium may optionally be included for color or fluorescence. Preferably, the microspheres are substantially free of lead oxide (PbO) and cadmium oxide (CdO).

In some embodiments, the microspheres comprise little or no other metal oxides.

In this embodiment, the amount of other metal oxides is no greater than 10, 9, 8, 7, 6, 5, 4, 3, 2, 1 or 0.5 wt. % of the microspheres.

In some embodiments, the microspheres typically have a density of at least 3.4 or 3.5. The density of the microspheres is typically no greater than 3.95. In some embodiments, the density is at least 3.6, 3.7, 3.8, or 3.9. In other embodiments, the density is less than 3.9, 3.8, 3.7, or 3.6.

Beads can be made and used in various sizes. It is uncommon to deliberately form beads smaller than 10 micrometers in diameter, though a fraction of beads down to 2 micrometers or 3 micrometers in diameter is sometimes formed as a by-product of manufacturing larger beads. Accordingly, the beads are typically at least 20, 30, 40, 50, 60, 70, 80, 90 or 100 micrometers. For example, in some embodiments, the d10 of the particle size distribution as measured as described in the examples, is typically at least 80, 90 or 100 micrometers. The beads are typically no greater than 1 to 2 mm. More commonly the beads, are no greater than 750, 500, or 300 microns. In some embodiments, the d90 of the particle size distribution is no greater than 300, 350, 200, or 150 microns.

The microspheres described herein can be prepared by any suitable method. In some embodiments, molded precursor green particles were prepared from slurries by following the general teachings of U.S. Pat. No. 8,701,441 (Kramlich et. al.), incorporated herein by reference. To form glass microspheres, molded precursor green particles were fed into a methane/oxygen torch flame (i.e. flame former) thereby generating glass microspheres.

The glass precursor composition used to form the spheres includes glass precursor particles and optionally at least one liquid of water, volatile organic liquid, and fugitive binder, i.e., a binder that dissipates during the elevated temperature processing used in forming the spheres. The glass precursor particles are preferably dispersed such that the composition forms a dispersion (e.g., a slurry). One example of a useful glass precursor composition is one that includes glass precursor particles and water and is in the form of a slurry.

The liquid (e.g. water) is typically present in the glass precursor composition in an amount of at least 5, 10, 15 or 20% by weight of the slurry composition. In some embodiments, the liquid is present in an amount no greater than 50, 40 or 30% by weight of the slurry composition.

Aqueous-based glass precursor compositions can include other additives including, e.g., hydrocolloids (e.g., xanthan, maltodextrin, galactomanan and tragacanth) polysaccharides, natural gums (e.g., gum Arabic), starch derivates, surfactants (e.g., cationic, anionic, nonionic, and zwitterionic) including, e.g., sodium lauryl sulfate polysorbate, and sodium 2-ethylhexyl sulfate, and combinations thereof.

Examples of useful volatile organic liquids include methanol, ethanol, isopropyl alcohol, butyl alcohol, heptane, and toluene.

Useful fugitive binders include water soluble and water dispersible binders including, e.g., dextrin, starch, cellulose, hydroxyethylcellulose, hydroxypropylcellulose, carboxyethylcellulose, carboxymethylcellulose, carragenan, scleroglycan, xanthan gum, guar gum, hydroxypropylguar gum and combinations thereof. Other suitable binders are described in U.S. Pat. No. 8,701,441.

The molded microparticles are then passed through a flame or other source of sufficient thermal energy (e.g., a gas-fired furnace or an electrical furnace) to form molten glass droplets. Any suitable sphere forming process and apparatus can be used including, e.g., glass, glass-ceramic, glass-bonded ceramic, and crystalline ceramic spheres manufacturing processes and apparatuses.

In one useful method, the molded microparticles are in the form of a free flowing powder and the passing involves allowing the free flowing powder to be dispersed in a flame. The flame has a temperature sufficient to transform, e.g., fuse, the glass precursors present in the molded microparticle into a homogenous state. The flame temperature is selected to be suitable for melting and fusing the molded microparticles into glass droplets. Useful flame temperatures are at least about 2000K, at least about 3000K, or even from about 3000K to about 5000K. The flame can be generated by any suitable fuel and oxidant sources including, e.g., natural gas, hydrogen, oxygen, acetylene, air, and mixtures thereof.

The duration of the molded microparticles in the flame is referred to as “residence time.” The residence time is selected to achieve spheres having a desired property(s). Variables that impact the residence time include, e.g., flame velocity, flame size, flame shape, flame temperature, molded microparticle volume, the composition of the molded microparticle, the density of the molded microparticle, and the density of the sphere. The molten droplets can be maintained in the flame for a sufficient period of time to transform the molten droplets into spheres through any suitable mechanism including, e.g., directing gas currents under the molten droplets, allowing the molten droplets to fall freely through the heating zone, and combinations thereof.

The fused glass droplets form spheroids, which are then quenched to form spheres. Various quenching methods are suitable including, e.g., air cooling (e.g., by free falling through a space a sufficient distance), rapid cooling and combinations thereof. A useful rapid cooling method includes allowing the spheroids to continue their free fall through a cooling zone or into a cooling medium, e.g., water, oil or a combination thereof. Alternately or in addition, a gas (e.g., air or argon) can be sprayed into the free falling stream of fused spheroids causing the spheroids to accelerate and cool forming solid, transparent glass microbeads.

The spheres are then collected and, where desired, further processed including, e.g., screening (which is also referred to as classifying, sieving and sizing), heat treating (e.g., to allow the spheres to develop crystallinity, to form glass-ceramic, glass-bonded ceramic, and crystalline ceramic spheres and combinations thereof), fully ceraming, and combinations thereof. Useful heat treating methods are disclosed, e.g., in U.S. Pat. No. 6,245,700 and incorporated herein.

Microspheres exhibiting X-ray diffraction consistent with the presence of a crystalline phase are considered glass-ceramic microspheres. An approximate guideline in the field is that materials comprising less than about 1 volume % crystals may not exhibit detectable crystallinity in typical powder X-ray diffraction measurements. Such materials are often considered “X-ray amorphous” or glass materials, rather than ceramic or glass-ceramic materials. Microspheres comprising crystals that are detectable by X-ray diffraction measurements, typically necessary to be present in an amount greater than or equal to 1 volume % for detectability, are considered glass-ceramic microspheres. X-ray diffraction data can be determined as described in the examples.

In typical embodiments, the microspheres may be characterized as amorphous microspheres or in other words “glass microspheres”.

The glass-ceramic microspheres comprise one or more crystalline (e.g. nanocrystalline) phases, typically totaling at least 5 volume %. Crystallinity is typically developed through heat-treatment of amorphous beads, although some glass-ceramic beads formed by quenching molten droplets may contain crystals without secondary heat treatment. Such a crystalline phase or phases may include relatively pure single-component metal oxide phases of titania (e.g., anatase, rutile) and/or zirconia (e.g., baddeleyite). Also, such a crystalline phase or phases may include relatively pure multicomponent metal oxide phases (e.g., ZrTiO4).

Upon initial formation from a melt, beads are formed that are substantially amorphous yet can contain some crystallinity. The compositions preferably form clear, transparent glass microspheres when quenched. Upon further heat treatment, the beadscan develop crystallinity in the form of a glass-ceramic structure, i.e., microstructure in which crystals have grown from within an initially amorphous structure, and thus become glass-ceramic beads. Upon heat treatment of quenched beads, the beads can develop crystallinity in the form of a nanoscale glass-ceramic structure, i.e., microstructure in which crystals less than about 100 nanometers in dimension have grown from within an initially amorphous structure, and thus become glass-ceramic beads. A nanoscale glass-ceramic microstructure is a microcrystalline glass-ceramic structure comprising nanoscale crystals. In some embodiments, the (e.g. titania-containing) transparent microbeads are mostly crystalline (i.e., greater than 50 vol-% crystalline) directly after quenching, thus bypassing a heat-treatment step. In some embodiments, the microspheres (e.g. have low concentrations or no titania) remain amorphous when heat treated to a temperature up to 950° C.

In some embodiments, the microspheres form a microcrystalline glass-ceramic structure via heat treatment yet remain transparent. For good transparency, it is preferable that the microspheres comprise little or no volume fraction of crystals greater than about 100 nanometers in dimension. Preferably, the microspheres comprise less than 20, 10, 15, or 5 volume % of crystals greater than about 100 nanometers in dimension. Preferably, the size of the crystals in the crystalline phase is less than about 20 nanometers (0.02 micrometers) in their largest linear dimension. Crystals of this size typically do not scatter visible light effectively, and therefore do not decrease the transparency significantly.

The microspheres typically have suitable whiteness for use in retroreflective articles as determined by the test method described in the examples. The whiteness index (“WI”) is typically at least 50. In some embodiments, the whiteness index is at least 51, 52, 53, 54, 55, 56, 57, 58, 59, or 60. In some embodiments, the whiteness index is no greater than 60, 59, 58, 57, 56, or 55.

The microspheres described herein have sufficient durability. The durability can be determined by various methods. In some embodiments, the retained brightness after sandblasting as described in the forthcoming examples is indicative of the durability of the microspheres and retroreflective articles. In some embodiments, the retroreflective article or microspheres have a retained brightness after sandblast of at least 65, 66, 67, 68, 69, or 70%. In some embodiments, the retained brightness is typically no greater than about 75%. In some embodiments, the retroreflective article or microspheres have a brightness after sandblast of at least 4, 5, 6, or 7 (Cd/m²)/lux.

The microspheres (e.g. of the retroreflective article) described herein have sufficient crush resistance. The crush resistance can be determined with the method described in U.S. Pat. No. 4,772,511. Using this procedure the beads can exhibit a median crush resistance of at least about 700, 750, 800, 850, 900, 950, or 1000 MPa. In some embodiments, the crush resistance is no greater than 1800, 1700, 1600, 1500, 1400, 1300, or 1200 MPa.

### EXAMPLES

Unless otherwise noted or readily apparent from the context, all parts, percentages, ratios, etc. in the Examples and the rest of the specification are by weight.

The following abbreviations are used in the Examples section: Cd=candelas, m=meters, cm=centimeters.

Materials Used in the Examples

| Abbreviation | Description and Source |
|---|---|
| Cell-gum | Sodium carboxymethylcellulose, available under the trade designation |
| | 7ULC from Hercules Incorporated, Aqualon Division, Wilmington, DE |
| Dispersant | Sodium polymethacrylate solution, available under the trade designation |
| | DAXAD 30 from Geo Specialty Chemicals, Ambler, PA |
| ZrO₂ | Zirconium (IV) Oxide, available under the trade designation CF PLUS - |
| | HM from Z - Tech LLC, Bow, NH |
| Al₂O₃ | Aluminum (III) Oxide, available under the trade designation A16 - SG |
| | from Alcoa Chemicals, Point Comfort, TX |
| SiO₂ | Silicon (IV) Oxide, available under the trade designation RS-50 from |
| | Vitro Minerals, Jackson, TN |
| TiO₂ | Titanium (IV) Oxide, available under the trade designation KRONOS |
| | 6501 from Kronos Worldwide, Inc., Dallas, TX |
| CaCO₃ | Calcium Carbonate, available under the trade designation HUBERCARB |
| | Q325 from Huber Engineered Materials, Atlanta, GA |
| Mg(OH)₂ | Magnesium Hydroxide, available from Sigma Chemical Company, St. |
| | Louis, MO |
| La₂O₃ | Lanthanum (III) Oxide, available from China Minmetals, Beijing, P.R. |
| | China |

### Test Methods

Index of Refraction Procedure: Index of refraction of the microspheres was measured according to T. Yamaguchi, “Refractive Index Measurement of High Refractive index Beads,” Applied Optics Volume 14, Number 5, pages 1111-1115 (1975). This data is presented in Table 4. Examples with a “reported were not transparent (i.e. crystalline) as made so no refractive index data could be generated.

Brightness Procedure: Dry white patch brightness values were determined using a retroreflectometer (Road Vista 932, obtained from Road Vista LLC, San Diego, CA). The device directs white light onto a flat monolayer of glass microspheres partially sunk into a diffuse white backing material (3M 7000-109-3 Patch Brightness Tape) at a set entrance angle to the normal of the partially sunk monolayer. The diffuse white backing material without the monolayer of glass microspheres had a whiteness index of 86 as measured according to the Color Procedure described below. Retroreflective brightness, i.e. patch brightness, is measured by a photodetector in the retroreflectometer at a fixed divergence angle to the entrance angle (observation angle) in units of (Cd/m²)/lux. Results presented in Table 4 were measured at a set −4° entrance angle with 0.2° observation angle. Retroreflective brightness measurements were made for the purpose of comparison of brightness between glass microspheres of different chemistry. The 0.2-degree observation angle data generated for this measurement is conforming with ASTM E1709.

Mechanical Durability Procedure: A sandblast abrasive wear test was performed. A test patch was prepared by embedding the glass microspheres to be tested into a 1.5 inch (3.8 cm) circular patch of 6-mil (0.15 mm) thick ethylene methacrylic acid (EMAA) film. The EMAA film was opaque white and filled with a pigment functioning as a diffuse reflector so that the patch retroreflective brightness could be measured both initially and after sandblasting. The patch was prepared by taking the 1.5 inch (3.8 cm) circular piece of EMAA film and affixing to the center of a 3 inch (7.6 cm)×3 inch (7.6 cm)×24 ga (0.607 mm) aluminum plate using double-sided adhesive tape. To embed the glass microspheres, the microsphere sample was first preheated in an oven to 120° C. Next, the patch was heated in the 120° C. oven for 60 seconds and then quickly removed and placed onto an insulating mat. The pre-heated microsphere sample was immediately poured onto the patch to tack the glass microspheres to the surface. Excess glass microspheres were then poured off the patch leaving a monolayer. The glass microspheres were further embedded into the EMAA film by placing the patch into a 130° C. oven for approximately 2-2.5 minutes. The soak time was adjusted to achieve a target microsphere embedment level of 30-40%. Embedment levels less than this range may result in loss of glass microspheres while embedment levels of 50% or greater will affect retroreflective brightness results. The prepared patch was then measured for initial dry retroreflective brightness according to the Brightness Procedure.

To perform the sandblast test, 200.0 grams of AO Fastblast #46 (35/50) mesh Al₂O₃ blasting media (Washington Mills Inc., North Grafton, MA, Product #22650046) was weighed into a cup. The sample patch/aluminum plate was rigidly mounted in a holder perpendicular to and in line with a sandblast gun at a distance of 20.0 inches (51 cm) from the nozzle exit of the gun. The gun's ceramic nozzle is 0.196 inches (0.498 cm) interior diameter by 2.3 inches (5.8 cm) long. An air flow of 1.50 standard cubic feet per minute (42.5 standard liters per minute) was metered into the gun using a Brooks Model 1307D08F1A1Z33 rotameter with a 60.0 pounds per square inch (413.7 kilopascals) in gauge compressed air supply. Next the cup of Al₂O₃ blasting media was poured into the feed inlet funnel of the gun all at once and the media was aspirated into the gun's air stream over a period of about 10-15 seconds.

The damaged patch was removed and then again measured for dry patch retroreflective brightness according to the Brightness Procedure. By dividing the post sandblast brightness by the initial dry patch brightness, a retained brightness percentage was reported as provided in Table 5.

Color Procedure: Whiteness index and color of the glass microspheres was measured using a Colorflex spectrophotometer (obtained from HunterLab, Reston, VA) configured with a C element 2-degree observer and conforming with ASTM E313 “Standard Practice for Calculating Yellowness and Whiteness Indices from Instrumentally Measured Color Coordinates.” The sample to be measured was prepared by filling a sample cup with a glass transparent bottom with at least 0.25 inches (0.64 cm) of glass microspheres. A 420-nanometer UV filter (1.25-inch UV port insert D02-1010-618 obtained from HunterLab, Reston, VA) was placed between the spectrophotometer light source and the cup holding the sample to be measured. The color data is reported in Table 6.

Crystallinity Procedure: To determine whether a sample of glass microspheres was crystalline or amorphous, x-ray diffraction (XRD) spectra of a bed of glass microspheres was obtained using an x-ray diffractometer (MiniFlex 600, obtained from Rigaku Americas Corporation, The Woodlands, TX). Microspheres that were majority amorphous exhibit broad diffuse spectra with no defined narrow peaks. Microspheres that have both crystalline and amorphous phases exhibit broad diffuse peaks with isolated defined peaks also present. Microspheres that are fully crystalline exhibit distinct peaks in the measured x-ray spectra with no presence of broad diffuse peaks.

Particle Size Distribution Procedure: Glass microsphere particle size distribution was determined using Mastersizer 3000 particle size analyzer with Hydro MV module obtained from Malvern Panalytical, Worcestershire, United Kingdom. An aqueous dispersion of microspheres was generated by the device and then light scattering patterns were measured to determine the particle size distribution of the sample. Data reported is the size at which a given volume fraction of the particles are below the referenced threshold. For example, in a sample with a d10 of 100 micrometers (microns, mm) 10% of the volume of the sample has a particle size less than 100 microns. Particle size distribution results are presented in Table 7.

Density Procedure: Glass microsphere density was determined by using a AccuPyc II 1345 gas displacement pycnometry system obtained from Micromeritics Instrument Corporation Norcross, GA. Approximately 20 grams of sample was loaded into the sample cup and the instruments standard density analysis was performed. Particle size distribution and density are reported in Table 7.

### Examples EX-1 Through EX-13 and Comparative Examples CE-1 Through CE-3

To prepare examples EX-1 through EX-13 and Comparative Examples CE-1 through CE-3, homogeneous slurries of mixed metal oxide powders were prepared by adding materials in the amounts indicated in Table 2 as follows. First, cell-gum was added to water in a 1200 mL stainless steel mixing jar very slowly and fully dissolving with aggressive high shear Cowles blade mixing for at least 10 minutes. Next, dispersant was added and mixed for at least 5 minutes. Then the SiO₂ powder was added very slowly over the course of 30 minutes to give the dispersant time to work and prevent flocculation. The remaining powders were then added slowly and mixed for 30 more minutes. The mixture was then transferred to a 1-liter high alumina grinding jar (obtained from U.S. Stoneware East Palestine, OH, under the trade designation “ROALAX”) with 1 cm cylindrical alumina media (obtained from U.S. Stoneware under the trade designation “BURUNDUM”) half filling the jar to be ball milled for at least 24 hours at 170 revolutions per minute to make a homogeneous aqueous suspension (slurry).

Molded precursor green particles were prepared from slurries by following the general teachings of U.S. Pat. No. 8,701,441 (Kramlich et. al.), which is incorporated herein by reference.

To form glass microspheres, molded precursor green particles were fed into a methane/oxygen torch flame (i.e. flame former). The flame former used to melt the particles, thereby generating glass microspheres, was a Bethlehem bench burner, obtained from Bethlehem Apparatus Co., Hellertown, PA, under the trade designation “Champion” which produces an oxygen enriched methane flame. The gas flow rates were CH₄ at 7.5 standard liters per minute (SLPM), O₂ at 15 SLPM, and 1 SLPM of argon push gas. The particles were fed into the flame former via an FMC Syntron Magnetic Feeder (Model FTO-C) feeder obtained from Syntron Material Handling Saltillo, MS, limiting the feed rate to ˜2.5-3 grams/minute. The flame formed microspheres were then screened at −212 microns to remove out of size defects. The cell-gum and dispersant are volatilized during flame forming and are not present in the final microspheres.

TABLE 2
Slurries

| | Amounts in Grams | | | | | | | | | |
|---|---|---|---|---|---|---|---|---|---|---|
| | Water | Cell-gum | Dispersant | ZrO₂ | Al₂O₃ | SiO₂ | TiO₂ | CaCO₃ | Mg(OH)₂ | La₂O₃ |
| CE-1 | 352.9 | 10.0 | 11.4 | 232.0 | 384.0 | 184.0 | | | | |
| CE-2 | 332.9 | 10.0 | 11.4 | 240.0 | 344.0 | 216.0 | | | | |
| CE-3 | 440.0 | 10.0 | 12.5 | 267.3 | 347.5 | 154.4 | | | 30.9 | |
| EX-1 | 332.9 | 10.0 | 11.4 | 320.0 | 320.0 | 160.0 | | | | |
| EX-2 | 332.9 | 10.0 | 11.4 | 360.0 | 320.0 | 120.0 | | | | |
| EX-3 | 332.9 | 10.0 | 11.4 | 320.0 | 360.0 | 120.0 | | | | |
| EX-4 | 332.9 | 10.0 | 11.4 | 280.0 | 400.0 | 120.0 | | | | |
| EX-5 | 332.9 | 10.0 | 11.4 | 400.0 | 320.0 | 80.0 | | | | |
| EX-6 | 332.9 | 10.0 | 11.4 | 360.0 | 360.0 | 80.0 | | | | |
| EX-7 | 332.9 | 10.0 | 11.4 | 320.0 | 400.0 | 80.0 | | | | |
| EX-8 | 332.9 | 10.0 | 11.4 | 280.0 | 440.0 | 80.0 | | | | |
| EX-9 | 332.9 | 10.0 | 11.4 | 360.0 | 400.0 | 40.0 | | | | |
| EX-10 | 332.9 | 10.0 | 11.4 | 360.0 | 340.0 | 100.0 | | | | |
| EX-11 | 332.9 | 10.0 | 11.4 | 342.0 | 323.0 | 95.0 | 40.0 | | | |
| EX-12 | 382.9 | 10.0 | 11.4 | 334.5 | 315.9 | 92.9 | | | 56.6 | |
| EX-13 | 332.9 | 10.0 | 11.4 | 340.3 | 321.4 | 94.5 | | | | 43.7 |

TABLE 3
Glass Microsphere Compositions

| Examples and | | | Amount | | |
|---|---|---|---|---|---|
| Comparative | | | of ZrO₂ + | | |
| Examples | ZrO₂ | Al₂O₃ | Al₂O₃ | SiO₂ | Other |
| CE-1 | 29.0 | 48.0 | 77.0 | 23.0 | |
| CE-2 | 30.0 | 43.0 | 77.0 | 27.0 | |
| CE-3 | 33.8 | 44.0 | 77.8 | 19.5 | 2.7 |
| | | | | | MgO |
| EX-1 | 40.0 | 40.0 | 80.0 | 20.0 | |
| EX-2 | 45.0 | 40.0 | 85.0 | 15.0 | |
| EX-3 | 40.0 | 45.0 | 85.0 | 15.0 | |
| EX-4 | 35.0 | 50.0 | 85.0 | 15.0 | |
| EX-5 | 50.0 | 40.0 | 90.0 | 10.0 | |
| EX-6 | 45.0 | 45.0 | 90.0 | 10.0 | |
| EX-7 | 40.0 | 50.0 | 90.0 | 10.0 | |
| EX-8 | 35.0 | 55.0 | 90.0 | 10.0 | |
| EX-9 | 45.0 | 50.0 | 95.0 | 5.0 | |
| EX-10 | 45.0 | 42.5 | 87.5 | 12.5 | |
| EX-11 | 42.8 | 40.4 | 83.2 | 11.9 | 5.0 |
| | | | | | TiO₂ |
| EX-12 | 42.8 | 40.4 | 83.2 | 11.9 | |
| EX-13 | 42.8 | 40.4 | 83.2 | 11.9 | 5.0 |
| | | | | | La₂O₃ |

TABLE 4
Brightness and Refractive Index

| Examples | | |
|---|---|---|
| and | | |
| Comparative | 0.2 degree observation angle −4 | |
| Examples | degree entrance angle | Refractive Index |
| CE-1 | 5.4 | 1.70 |
| CE-2 | 5.7 | 1.70 |
| CE-3 | 7.9 | 1.72 |
| EX-1 | 8.0 | 1.74 |
| EX-2 | 10.1 | 1.77 |
| EX-3 | 8.8 | 1.75 |
| EX-4 | 8.0 | 1.73 |
| EX-5 | 13.1 | 1.82 |
| EX-6 | 11.6 | 1.80 |
| EX-7 | 10.1 | 1.76 |
| EX-8 | 8.1 | 1.72 |
| EX-9 | 10.3 | 1.80 |
| EX-10 | 9.9 | 1.78 |
| EX-11 | 8.5 | 1.82 |
| EX-12 | 10.2 | 1.78 |
| EX-13 | 11.4 | 1.80 |

TABLE 5
Sandblast Patch Brightness

| | 0.2 degree observation angle −4 degree | | |
|---|---|---|---|
| Examples and | entrance angle | | Brightness |
| Comparative | Before | After | Retention |
| Examples | Sandblast | Sandblast | % |
| CE-1 | 4.63 | 3.27 | 71% |
| EX-1 | 6.6 | 4.9 | 74% |
| EX-2 | 8.1 | 5.8 | 72% |
| EX-3 | 7.2 | 5.2 | 72% |
| EX-5 | 10.1 | 7.2 | 72% |
| EX-6 | 9.5 | 6.7 | 71% |
| EX-10 | 8.55 | 6.03 | 71% |

The microspheres of EX-11 and EX-13 were heated treated at a rate of 10C/min to 950 C. and held at 950 C for 1 hour. The brightness and refractive index were evaluated as previously described. The results are as follows:

| Heat | | |
|---|---|---|
| Treated | 0.2 degree observation angle −4 | |
| Examples | degree entrance angle | Refractive Index |
| EX-11HT | 14.2 | 1.85 |
| EX-13HT | 13.9 | 1.82 |

TABLE 6
Whiteness and Color

Examples

and

| Comparative | Whiteness and Color Data | | | | X-Ray Diffraction |
|---|---|---|---|---|---|
| Examples | L | a | b | WI E313 [C/2] | Phases Observed |
| CE-1 | 86.4 | −1.9 | 2.8 | 60.8 | Amorphous |
| EX-1 | 85.7 | −2.2 | 3.0 | 58.3 | Amorphous |
| EX-2 | 85.4 | −2.7 | 3.7 | 54.2 | Amorphous |
| EX-3 | 84.6 | −2.3 | 3.1 | 55.9 | Amorphous |
| EX-5 | 85.0 | −3.2 | 4.4 | 49.8 | NM |
| EX-6 | 84.3 | −2.6 | 3.7 | 52.5 | Amorphous |
| EX-10 | 84.7 | −2.9 | 3.9 | 51.9 | Amorphous |
| EX-11 | 35.7 | 0.5 | 4.2 | −39.9 | Amorphous |
| EX-11HT | | | | NM | Crystalline |
| EX-12 | 84.9 | −3.3 | 4.2 | 50.8 | Amorphous |
| EX-13 | 84.0 | −3.1 | 3.5 | 52.7 | Amorphous |
| EX-13HT | | | | NM | Crystalline |

NM = not measured

TABLE 7
Particle Size Distribution and Density

| Examples and Comparative | Particle Size Distribution | | | |
|---|---|---|---|---|
| Examples | d10 mm | d50 mm | d90 mm | Density (g/cc) |
| CE-1 | 104 | 126 | 151 | 3.30 |
| CE-2 | 115 | 131 | 147 | 3.25 |
| CE-3 | 104 | 126 | 151 | 3.3 |
| EX-1 | 111 | 125 | 142 | 3.54 |
| EX-2 | 113 | 126 | 142 | 3.72 |
| EX-3 | 112 | 127 | 143 | 3.62 |
| EX-4 | 113 | 127 | 142 | 3.53 |
| EX-5 | 111 | 122 | 140 | 3.92 |
| EX-6 | 110 | 123 | 141 | 3.81 |
| EX-7 | 112 | 124 | 141 | 3.70 |
| EX-8 | 113 | 126 | 142 | 3.59 |
| EX-9 | 112 | 124 | 141 | 3.87 |
| EX-10 | 113 | 127 | 142 | 3.76 |
| EX-11 | 112 | 124 | 140 | 3.77 |
| EX-12 | 105 | 119 | 136 | 3.73 |
| EX-13 | 111 | 123 | 141 | 3.85 |

The crush resistance of exemplified beads was determined according to the test procedure described in U.S. Pat. No. 4,772,511 (Wood) using an apparatus having two parallel plates made of very hard, nondeforming material (e.g., sapphire or tungsten carbide). A single microsphere of known diameter is placed on the lower plate and the upper plate lowered until the microsphere fails. Crush resistance is the force exerted on the microsphere at failure divided by the cross-sectional area of the microspheres (71′r2). Ten microspheres of a given composition are tested and the average result is reported as the crush resistance for the composition.

TABLE 8
Crush Strength

| Examples and Comparative Examples | Crush Resistance (MPa) |
|---|---|
| CE-2 | 931 |
| EX-2 | 876 |
| EX-5 | 1028 |
| EX-10 | 951 |

1. A retroreflective article comprising microspheres disposed on a surface of the article wherein the microspheres comprise
at least 40 wt. % alumina,
at least 35 wt. % zirconia, and
silica.

2. The retroreflective article of claim 1 wherein the article is a pavement marking or pavement marking tape.

3. The retroreflective article of claim 1 wherein the retroreflective article is a retroreflective element comprising a core particle comprising the microspheres at least partially embedded in a core.

4. The retroreflective article of claim 1 wherein the microspheres comprise amorphous microspheres.

5. The retroreflective article of claim 1 wherein the microspheres comprise nanocrystalline glass ceramic microspheres.

6. The retroreflective article of claim 1 wherein the microspheres are transparent.

7. The retroreflective article of claim 1 wherein the microspheres comprise at least 40, 45, or 50 wt. % zirconia.

8. The retroreflective article of claim 1 wherein the microspheres comprise no greater than 20, 15, 10, or 5 wt. % silica.

9. The retroreflective article of claim 1 wherein the zirconia, alumina, and silica total at least 80, 85, 90, 95, or 100 wt. % of the microspheres.

10. The retroreflective article of claim 1 wherein the microspheres further comprise one or more other oxides in an amount no greater than 10 wt. %.

11. The retroreflective article of claim 1 wherein the microspheres have a refractive index of at least 1.72, 1.73, 1.74, 1.75, 1.76, 1.77, 1.78, 1.79, 1.80, 1.81, 1.82, 1.83, 1.84, or 1.85.

12. The retroreflective article of claim 1 wherein the retroreflective article or microspheres have a brightness at a 0.2 degree observation angle and −4 degree entrance angle of at least 8, 9, 10, 11, 12, 13, 14, or 15 (Cd/m²)/lux.

13. The retroreflective article of claim 1 wherein the microspheres have a density of at least 3.4 or 3.5.

14. The retroreflective article of claim 1 wherein the retroreflective article or microspheres microspheres have a retained brightness after sandblast of at least 65% or 70%.

15. The retroreflective article of claim 1 wherein the retroreflective article or microspheres microspheres have a brightness after sandblast of at 4, 5, 6, or 7 (Cd/m²)/lux.

16. The retroreflective article of claim 1 wherein the retroreflective article or microspheres microspheres have a whiteness index of at least 50, 55, or 60.

17. Microspheres comprising:
at least 40 wt. % alumina,
at least 35 wt. % zirconia, and
silica.

18. Microspheres comprising at least 80 wt. % of a combination of alumina, zirconia and silica wherein the microspheres have a density of at least 3.4.

19. Microspheres comprising at least 80 wt. % of a combination of alumina, zirconia and silica wherein the microspheres have a median crush strength of at least 700 MPa.

20. (canceled)

21. A retroreflective article comprising microspheres according to claim 18 disposed on a surface of the article.
